(19) United States
(12) Patent Application Publication
(10) Pub. No.: US 2024/0208101 A1
(43) Pub. Date: Jun. 27, 2024

(54) AUTOMATIC MACHINE FOR THE PRODUCTION OF ELECTRICAL ENERGY STORAGE DEVICES STARTING FROM AT LEAST ONE STRIP OF MATERIAL AND MOTION TRANSMISSION ASSEMBLY

(71) Applicant: MANZ ITALY S.R.L., SASSO MARCONI (BO) (IT)

(72) Inventors: Massimiliano Sale, SASSO MARCONI (BO) (IT); Luca Zambonelli, SASSO MARCONI (BO) (IT); Pasqualino Alongi, SASSO MARCONI (BO) (IT); Sergio Cirino, SASSO MARCONI (BO) (IT)

(73) Assignee: MANZ ITALY S.R.L., SASSO MARCONI (BO) (IT)

(21) Appl. No.: 18/567,962

(22) PCT Filed: Jun. 8, 2022
(86) PCT No.: PCT/IB2022/055344

§ 371 Date: Dec. 7, 2023

(30) Foreign Application Priority Data
Jun. 10, 2021 (IT) 102021000015245

(51) Int. Cl. B26D 5/22; B26D 1/08; H01M 10/04

(52) U.S. Cl. CPC B26D 5/22; B26D 1/085; H01M 10/0404

(57) ABSTRACT

Automatic machine for the production of electrical energy storage devices comprising: a feeding unit for feeding at least one strip of material along a feeding path; a cutting and conveying apparatus for cutting and conveying the strip comprising a slide linearly movable with reciprocating motion parallel to the feeding path between a retracted position and an advanced position, the slide carries a gripping assembly for sequentially gripping the strip at successive portions thereof, and a cutting assembly for sequentially cutting the strip when the latter is gripped by the gripping assembly; and a rotary actuator configured to control the reciprocating motion of the slide; the machine comprises a motion transmission assembly for transforming a rotary motion output from the rotary actuator into the reciprocating motion of the slide.

### CROSS-REFERENCE TO RELATED APPLICATIONS

This Patent application claims priority from Italian Patent Application No. 102021000015245 filed on Jun. 10, 2021, the entire disclosure of which is incorporated herein by reference.

### TECHNICAL FIELD OF THE INVENTION

The present invention relates to an automatic machine for the production of electrical energy storage devices starting from at least one strip of material, in particular an automatic machine comprising a cutting and conveying apparatus for cutting and conveying a strip of electrode for the production of such storage devices.

The present invention also relates to a motion transmission assembly from a rotary actuator to a slide movable with reciprocating motion, in particular a slide of a cutting and conveying apparatus for cutting and conveying a strip of material for the production of electrical energy storage devices.

In particular, the present invention is advantageously, but not exclusively, applied to the production of rechargeable batteries, more in particular to the production of planar batteries in metal can or enveloped (commonly called of the pouch type), to which the following description will explicitly refer without thereby losing generality.

### STATE OF THE ART

Automatic machines for the production of electrical energy storage devices are known, and in particular of rechargeable batteries or of capacitors.

Rechargeable batteries usually comprise two layers of electrode (cathode and anode) and at least two layers of separator arranged staggered with respect to one another according to an alternated electrode-separator-electrode-separator scheme.

In the case of cylindrical batteries, it is known to feed by means of respective feeding units of the aforementioned automatic machines the strips of electrode and the strips of separator along different feeding paths which all converge towards a rotating winding core, which is configured to retain and wind (generally about an elongated-shaped support) the strips of electrode and the strips of separator arranged staggered with respect to one another, so as to form a cylindrical winding.

In the case of planar batteries in metal can or enveloped, also known as pouch batteries, the strips of electrode and separator are fed along respective feeding paths for converging all of them towards a rolling unit, inside which they are laminated together. If necessary, during the lamination, the aforementioned strips of electrode and separator are arranged between two further protection layers (these too strip-shaped). Such protection layers are configured to protect the strips of electrode and separator inside the rolling unit and are usually removed at the exit from this unit.

Specifically, the strips of electrode and the strips of separator are fed to a pair of input rollers of the rolling unit, in a synchronized manner.

More precisely, each strip of electrode is sequentially cut (singularized) at respective transverse cutting sections, so as to obtain portions of strip (known as plates or blanks) defining the electrodes (for example the cathode or the anode) of each cell which will subsequently compose the planar battery. The portions of strip previously cut are fed to the aforementioned input rollers of the rolling unit, in a synchronous manner with the strips of separator.

Downstream of the rolling unit, in some cases, the multilayer planar strip composed of the two cut strips of electrode (i.e. the electrode plates) and the two strips of separator (still continuous), is cut transversely so as to obtain a sequence of planar cells separated from one another which will be subsequently stacked and enveloped so as to obtain an enveloped planar battery. In other cases, instead, the multilayer planar strip is wound about a flat pin so as to superimpose with precision the electrode plates forming a planar winding.

In order to prepare the electrodes and feed them to the rolling unit, the automatic machines for the production of planar batteries (stacked or wound) comprise respective cutting and conveying apparatuses, one for each electrode (i.e. one for the cathode and one for the anode), including a gripping assembly and a cutting assembly.

In each one of these apparatuses, the strip of electrode is conveyed along a portion of the relative feeding path up to the gripping assembly which is linearly movable with reciprocating motion (parallel to the strip of electrode) and comprises two grippers arranged on opposite sides of the strip of electrode which close retaining the strip, once the linear speed of the strip of electrode has been reached by means of the reciprocating motion.

Once the grippers have gripped the strip of electrode, the cutting assembly, comprising a blade member and it too movable with reciprocating motion integrally with the gripping assembly, cuts the strip of electrode upstream of the gripping assembly, relative to the advancement direction of the strip.

In other words, the entire cutting and conveying apparatus, which carries the gripping assembly and the cutting assembly, is linearly and cyclically movable with reciprocating motion between a retracted position, spaced from the rolling unit, and an advanced position, close to the rolling unit for feeding to the latter the cut electrode. Between these two positions, the apparatus reaches the linear advancement speed of the strip of electrode so as to grip it and cut it without causing undesired tensioning or stretching therein.

The cutting and conveying apparatus thus defines a slide carrying the gripping assembly and the cutting assembly and cyclically movable with reciprocating linear motion between the aforementioned positions.

Once the cutting of the strip of electrode has been completed, the cutting and conveying apparatus completes its linear advancement motion towards the advanced position and the rolling unit, slowing down and feeding (or “delivering”) to the input rollers of the latter the electrode that has just been cut and separated from the strip of electrode.

In the automatic machines of the known type, the linear movement of the gripping assembly and of the cutting assembly (and thus of the slide of the cutting and conveying apparatus) is carried out by means of an electric linear motor (in particular of brushless type).

Such linear motor is subject to extreme accelerations in the case of high production speeds.

In other words, the linear motor, burdened by its own weight, by the weight of the gripping assembly and by that of the cutting assembly, accelerates up to reaching the linear speed of the strip to be cut and, after the cut, decelerates while the flap of cut strip is kept gripped. Such flap remains partially hanging from the gripping assembly and is fed to the aforementioned input rollers. The entire apparatus thus needs a certain deceleration and braking space, since the first support for the flap (i.e. the pair of input rollers), successive to the gripping assembly, is necessarily distant from the cutting point because the gripping assembly (and, in particular, the entire apparatus) has to be allowed decelerating.

In order to partially overcome these problems, it has become necessary to increase the dimensions of the linear motor, increasing though the mass thereof. Consequently, for high speed productions of the strips (i.e. at least at hundreds of mm per second) for planar batteries, also having reduced dimensions, the linear motor has disproportionally imposing dimensions with respect to the rest of the automatic machine, since it needs the space and the torque necessary for accelerating all the cutting and conveying apparatus up to the linear speed of the strip of electrode and subsequently decelerating, after the cut, until stopping, and then moving back to the retracted position and restarting the cycle.

All this thus leads to increasing the bulks and the costs of the automatic machine and further determines productivity limits (in terms of cuts per minute) due to the necessary acceleration/deceleration spaces.

### Subject and Summary of the Invention

The object of the present invention is to manufacture an automatic machine for the production of electrical energy storage devices and a relative motion transmission assembly, which are highly reliable and have a limited cost, and allow overcoming at least some of the above-specified drawbacks connected to the aforementioned automatic machines of known type.

According to the invention, this object is achieved by an automatic machine for the production of electrical energy storage devices and by a motion transmission assembly according to what claimed in the following independent claims and, preferably, in any one of the claims directly or indirectly dependent on the independent claims.

The claims describe preferred embodiments of the present invention forming integral part of the present description.

### BRIEF DESCRIPTION OF THE DRAWINGS

In order to better understand the present invention, a preferred non-limiting embodiment is described in the following, by way of mere example and with the aid of the accompanying drawings, wherein:

FIG. 1 is a schematic side view, with parts removed for clarity, of part of an automatic machine for the production of electrical energy storage devices manufactured according to the present invention;

FIGS. 2, 3 and 4 are schematic side views, on an enlarged scale and with parts removed for clarity, of two cutting and conveying apparatuses of the automatic machine of FIG. 1 during three different and successive operating conditions;

FIGS. 5 to 8 are bottom schematic views, on an enlarged scale and with parts removed for clarity, of part of a transmission assembly of the automatic machine of FIG. 1, during two different motion configurations and four respective operating conditions;

FIG. 9 is a perspective view, on an enlarged scale and with parts removed for clarity, of part of a cutting and conveying apparatus of the machine of FIG. 1 and wherein the transmission assembly is partially visible;

FIG. 9a is an exploded perspective view, on an enlarged scale and with parts removed for clarity, of part of the transmission assembly;

FIGS. 10 and 11 illustrate in a schematic side view, on an enlarged scale and with parts removed for clarity, a further transmission assembly of the automatic machine of FIG. 1 during two different operating conditions; and

FIG. 12 illustrates in a perspective view, on an enlarged scale and with parts removed for clarity, the further transmission assembly schematized in FIGS. 10 and 11.

### DETAILED DESCRIPTION OF PREFERRED EMBODIMENTS OF THE INVENTION

With reference to the accompanying figures, reference numeral 1 indicates, as a whole, an (part of an) automatic machine for the production of electrical energy storage devices (not illustrated), in particular rechargeable batteries, starting from a plurality of strips 3 of material for the production of the storage devices.

In particular, the following description will explicitly refer, without thereby losing generality, to planar rechargeable batteries in metal can or enveloped, also known as batteries of the pouch type, which are obtained by laminating together strips of electrode (in particular a strip of anode and a strip of cathode) and strips of separator interposed between the strips of electrode in a staggered manner, according to a known scheme not specifically described. Conveniently, during the lamination, the strips are covered by further protection layers (these too strip-shaped), usually made of plastic film, which are removed and rewound following the lamination.

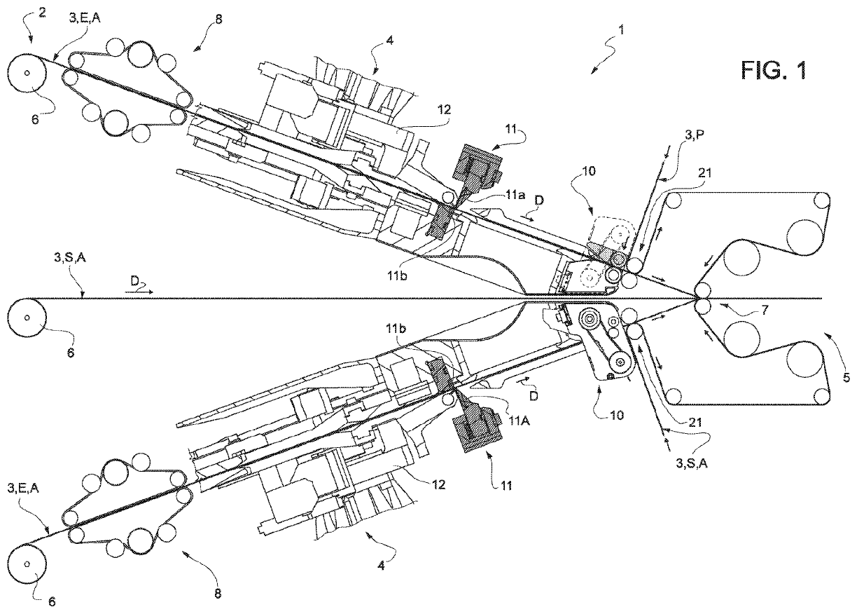

As is schematically shown in FIG. 1, the machine 1 comprises:
a feeding unit 2 for feeding at least one strip 3 of material for the production of the storage devices along a respective feeding path A and in an advancement direction D;
at least one cutting and conveying apparatus 4 for cutting and conveying the at least one strip 3 arranged downstream of the feeding unit 2 relative to the advancement direction D; and
a rolling unit 5 arranged downstream of the cutting and conveying apparatus 4, relative to the advancement direction D, and configured to receive the strip 3 and laminate it with at least another strip 3 of material for the production of the storage devices.

In particular, the feeding unit 2 is configured to feed a plurality of strips 3 initially wound in reels 6 along respective feeding paths A and respective advancement directions D.

It is specified that the advancement direction D indicates, in the present description, a direction parallel to the relative feeding path A in every point thereof and substantially extending from the feeding unit 2 to the rolling unit 5.

According to the preferred embodiment described and illustrated herein, the feeding unit 2 is configured to feed:
two strips 3 of electrode E (for example a strip of cathode and a strip of anode) along respective feeding paths A; and
two strips 3 of separator S along respective feeding paths A.

In particular, as is shown in FIG. 1:
the feeding path A of each strip 3 of electrode E extends from the relative reel 6 to the rolling unit 5, passing through a respective cutting d conveying apparatus 4; and
the feeding path A of each strip of separator S extends from the respective reel 6 to the rolling unit 5 without passing through any cutting and conveying apparatus 4.

Conveniently, the machine 1 comprises unwinding rollers (not illustrated) configured to support the strips 3 of separator S along the respective feeding paths A.

Preferably, the feeding unit 2 is also configured to feed a strip 3 of protection layer P along a respective feeding path and up to the rolling unit 5, for using the same as protection of the strips 3 of electrode E and separator S during the lamination of the latter. In other words, the strip 3 of protection layer P acts as intermediate layer between lamination rollers (known and not illustrated) of the rolling unit 5 and the strips 3 of electrode E and separator S.

In the non-limiting example described herein, the rolling unit 5 comprises a pair of opposing input rollers 7 configured to receive all of the previously mentioned strips 3.

In particular, the feeding paths A of the strips 3 of electrode E, of separator S and of the protection layer P converge at the input rollers 7, through which all the strips 3 enter the unit 5 for being laminated together (by means of the aforementioned lamination rollers), according to a known procedure not specifically described, thus obtaining a multilayer planar composite strip, comprising, in particular composed of, two continuous strips 3 of separator S between which the cut strips 3 of electrode E (i.e. the electrode plates) are interposed in a singularized manner, at a certain distance from one another, so that a plate of a strip 3 of anode faces (with a strip 3 of separator S in the middle) a plate of a strip 3 of cathode.

Downstream of the rolling unit 5, the multilayer planar strip is cut transversely (in particular between one electrode plate and the other) for obtaining a sequence of cells for planar batteries separated from one another. Specifically, the cells obtained following the cut successive to the lamination are monocells, which comprise two layers of electrode E and two layers of separator S alternated with respect to one another and laminated.

For the sake of brevity, reference will be made in the following to one single cutting and conveying apparatus 4 for cutting and conveying a strip 3 of electrode E of the machine 1. However, the structural and functional characteristics of such apparatus 4 are equally applicable to the other apparatus 4 and to every cutting and conveying apparatus possibly present in the machine 1.

The cutting and conveying apparatus 4 is configured to prepare the strip 3 of electrode E prior to the feeding thereof to the rolling unit 5.

According to an alternative embodiment not illustrated, the strip 3 treated and prepared by the apparatus 4 is defined by one or more strips 3 of separator S or by a strip of electrode/separator (multilayer) composite material.

The apparatus 4 comprises:
a conveying unit 8, preferably a belt conveyor having a fixed or variable geometry and arranged on opposite sides of the feeding path A, between which the strip 3 transits, and configured to move the strip 3 along the feeding path A in the advancement direction D;
a gripping assembly 10 arranged downstream of the conveyor 8, linearly movable with reciprocating motion (in particular intermittent/cyclic) parallel to the feeding path A and configured to sequentially grip the strip 3 at successive portions thereof; and
a cutting assembly 11 integral in motion with the gripping assembly 10, i.e. it too linearly movable with reciprocating motion integrally with the gripping assembly 10, and configured to sequentially cut the strip 3 when the latter is gripped by the gripping assembly 10 for determining the sequential separation (i.e. the singularization) of said successive portions from the strip 3.

Specifically, the cutting assembly 11 comprises a blade 11a and a counter-blade 11b arranged on opposite sides of the feeding path A and adapted to cooperate together for cutting the strip 3 transversely, in particular transverse to the advancement direction D or to a longitudinal extension of the strip 3, in order to separate each portion of strip previously gripped by the gripping assembly 10.

Obviously, it is understood that the positions of the blade 11a and counter-blade 11b can be exchanged between one another with respect to what illustrated in the figures, without thereby departing from the scope of protection of the present application.

In the preferred and non-limiting embodiment illustrated herein, the blade 11a is movable with reciprocating motion (towards and away from the counter-blade 11b, which instead is fixed) along a cutting direction T transverse to the feeding path A (and to the advancement direction D) for sequentially cutting the strip 3.

In an alternative embodiment not illustrated, the counter-blade 11b is movable with the aforementioned reciprocating motion and the blade 11a is fixed.

In a further alternative embodiment not illustrated, the blade 11a and the counter-blade 11b are both movable with reciprocating motion moving away and moving close to one another.

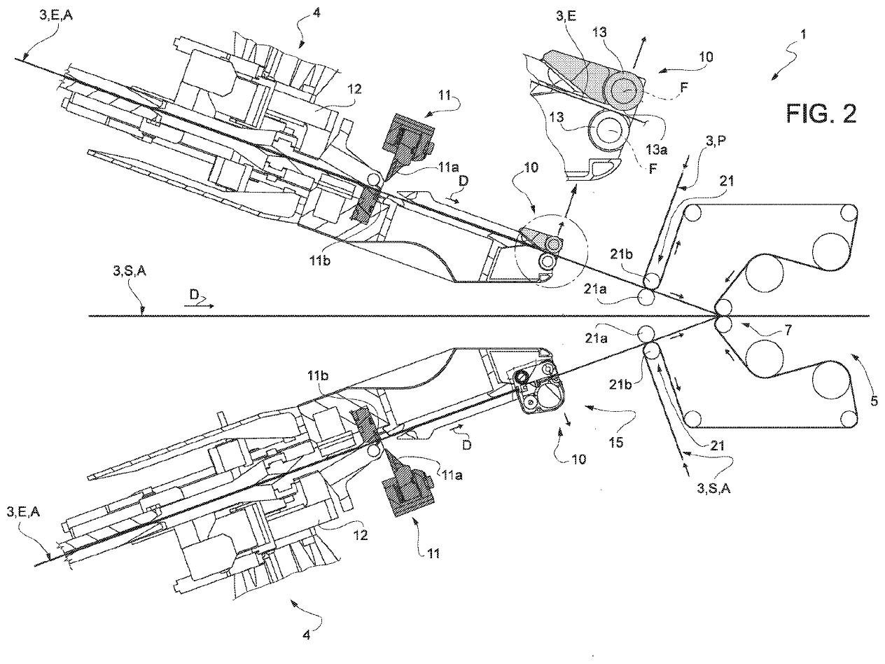

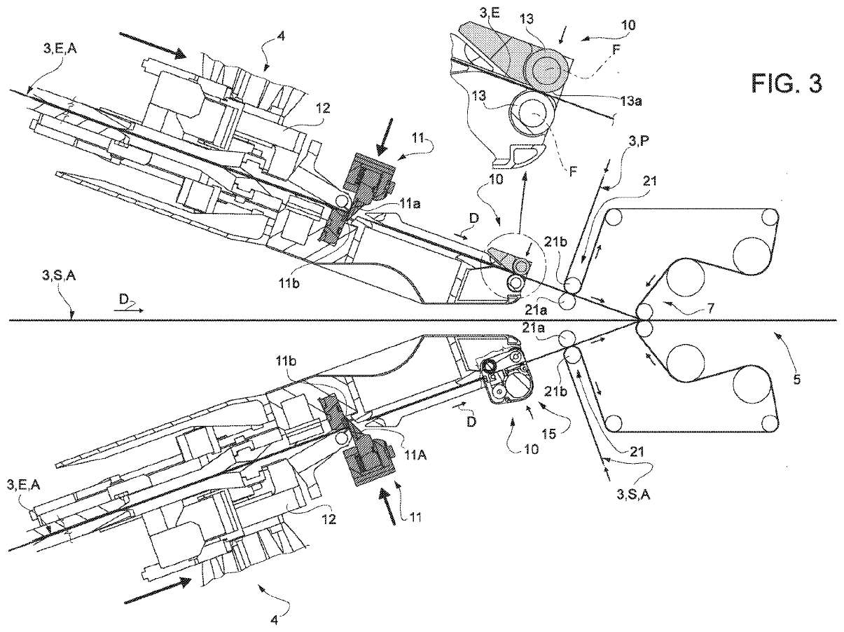

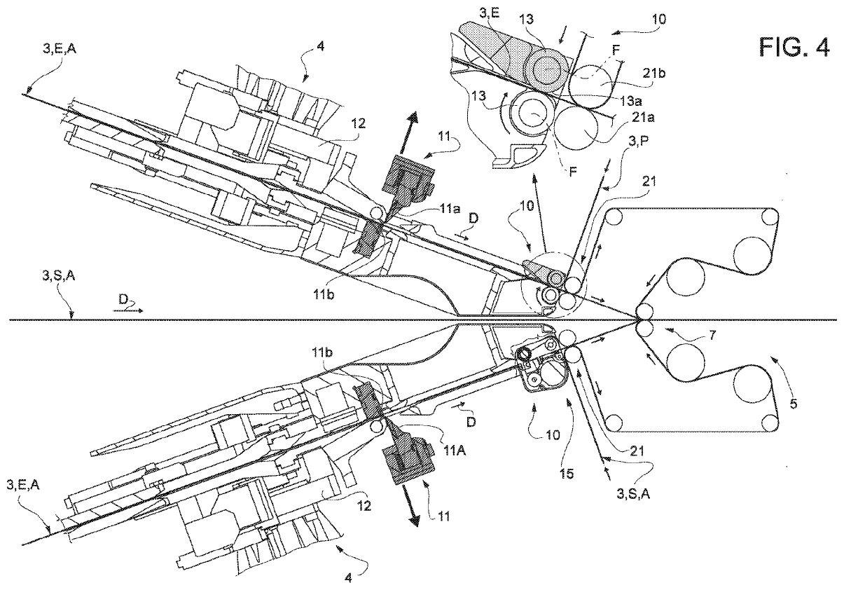

The apparatus 4 comprises a slide 12 carrying the gripping assembly 10 and the cutting assembly 11 and linearly movable with reciprocating motion, parallel to the feeding path A, between a retracted position (FIG. 2) and an advanced position (FIG. 4). FIG. 3 shows an intermediate position of the slide 12.

Specifically, when the slide 12 is arranged in the retracted position the gripping assembly 10 is arranged at a first distance from the rolling unit 5, in particular from the input rollers 7; when the slide 12 is arranged in the advanced position, the gripping assembly 10 is arranged at a second distance from the rolling unit 5, in particular from the input rollers 7, which is less than the first distance.

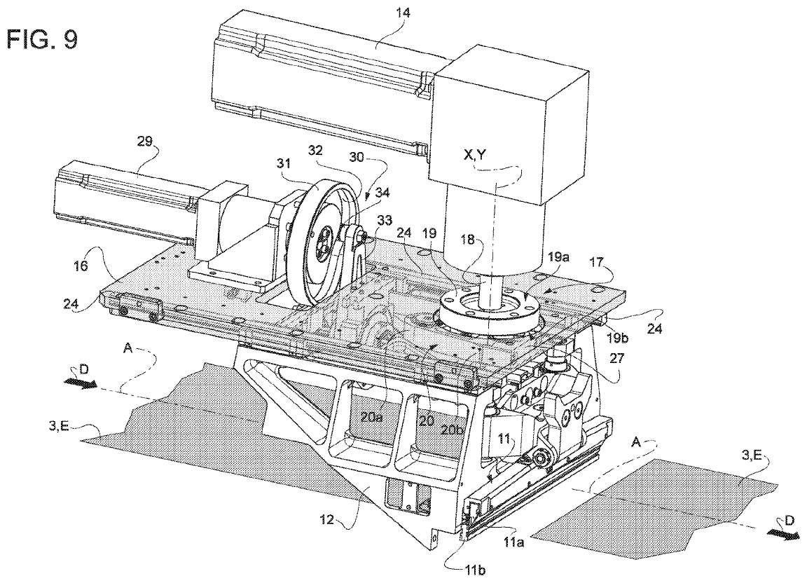

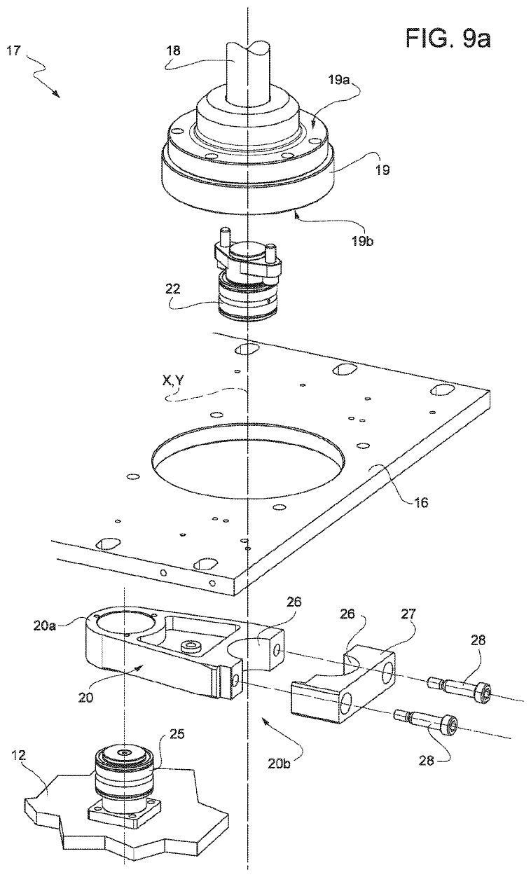

Conveniently, the apparatus 4 comprises linear guiding tracks 24 fixed to a fixed frame 16 of the machine 1, partially illustrated in FIG. 9, and engaged in a slidable manner by the slide 12, in particular by respective sliding blocks of the slide 12, for linearly guiding the slide 12 during the reciprocating movement thereof between the retracted position and the advanced position.

In order to move the slide 12, and thus the gripping assembly 10 and the cutting assembly 11, with cyclic reciprocating motion between the retracted position and the advanced position, the machine 1 advantageously comprises a rotary actuator 14 (FIG. 9), in particular an electric rotary motor, for example of the brushless type, known per se and not specifically described.

The rotary actuator 14 is carried by the fixed frame 16 of the machine 1, and is thus fixed with respect to the portion of machine 1, unlike the slide 12 which is movable.

In practice, the rotary actuator 14 controls, according to a mode described in the following, the quick reciprocating movement of the slide 12 between the retracted position and the advanced position.

As is known, the reciprocating linear movement of the gripping assembly 10 and of the cutting assembly 11 is necessary in order to grip and cut the strip 3 at the linear advancement speed of the strip 3 along the feeding path A, so as to prevent undesired tensioning or stretching, which can generally cause breakages of the material and the need for a machine stop.

In other words, the rotary actuator 14 controls the movement of the slide 12 so that the gripping assembly 10 and the cutting assembly 11 reach, for at least part of the movement of the slide between the retracted position and the advanced position, the linear advancement speed of the strip 3. In particular, the cutting assembly 11 is configured to complete the cut (opening blade 11a and counter-blade 11b) before the slide 12 starts decelerating, i.e. while the slide 12 moves at the linear advancement speed of the strip 3.

As is visible in FIGS. 9 and 9a, the machine 1 further comprises a motion transmission assembly 17 operatively interposed between the rotary actuator 14 and the slide 12 for transforming a rotary motion output from the rotary actuator 14 into the reciprocating motion of the slide 12.

Specifically, the transmission assembly 17 includes:
a drive shaft 18 carried by the fixed frame 16, having a longitudinal rotation axis X and coupled to the rotary actuator 14 for receiving the rotary motion from the latter, in particular by means of a transmission known per se and not illustrated;
a crank member 19 coupled to the drive shaft 18 for receiving the rotary motion from the latter; and
a connecting rod member 20 coupled, at a first portion 20a thereof, to the slide 12 and couplable, at a second portion 20b thereof opposite the first one, to the crank member 19 eccentrically with respect to said rotation axis X for receiving the rotary motion from the crank member 19 and transforming it into said reciprocating motion.

More specifically, the transmission assembly 17 comprises a coupling flange 19 defining the crank member, interposed between the drive shaft 18 and the connecting rod member 20, carried by the drive shaft 18 coaxially to the rotation axis X, couplable to the second portion 20b by means of a coupling pin 22 (for example a bearing) and having at least two seats 23 eccentric with respect to the rotation axis X configured to receive the pin 22.

More precisely, the flange 19 has a rotation axis Y and is mounted coupled to the drive shaft 18 with the axis Y coaxial to the axis X. Therefore, the seats 23 are obtained eccentric with respect to the rotation axis Y and are arranged eccentric with respect to the rotation axis X in mounting operating conditions.

Advantageously, the at least two eccentric seats 23 are arranged at respective radial distances L, M from the axis X (or from the axis Y) distinct from one another.

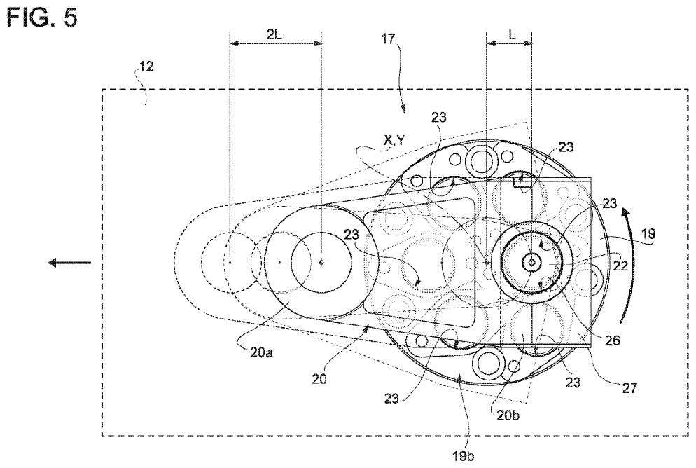

In particular, as is visible in FIGS. 5 to 8, the seats 23 have a circular shape and the aforementioned radial distances L, M are measured from the respective centers of the seats 23 to the rotation axis Y (or to the axis X, in mounting conditions of the flange 19 to the drive shaft 18).

In the present embodiment, the flange 19 comprises six seats 23 arranged at six respective radial distances distinct from one another from the axis X (and thus from the axis Y).

In the light of the foregoing, the flange 19 defines a crank member of the transmission assembly 17 whose extension is defined by the radial distance between the eccentric seat 23 engaged by the pin 22, for defining the coupling between the connecting rod member 20 and the flange 19, and the rotation axis X (or Y).

According to the invention, such extension is thus variable depending on the eccentric seat 23 engaged by the pin 22.

In other words, the transmission assembly 17 defines a connecting rod-crank-piston mechanism (or crank mechanism) wherein: the crank is defined by the flange 19, which receives the rotary motion from the drive shaft 18; the connecting rod is defined by the connecting rod member 20; the piston is defined by the slide 12 linearly guided by the tracks 24.

Therefore, the stroke of the slide 12 will be defined by twice as much the extension of the crank, i.e. by twice as much the radial distance L, M of the seat 23 engaged by the pin 22 from the axis X (or Y).

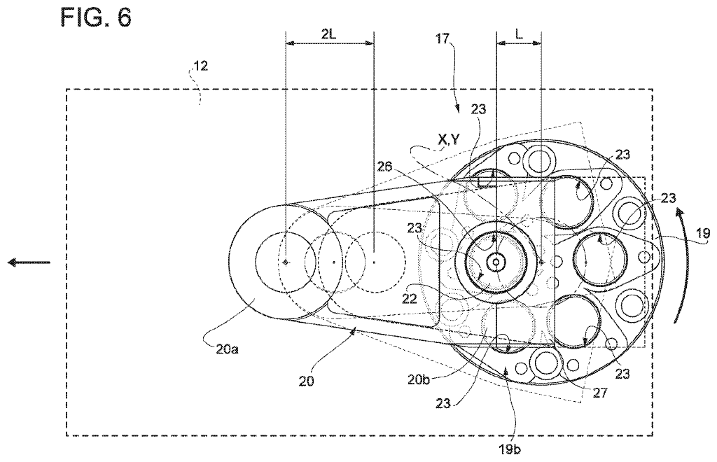

For example, with reference to FIGS. 5 and 6, when the pin 22 engages the seat 23 placed at a radial distance L from the axis X for defining the coupling between the connecting rod member 20 and the flange 19, the crank member (defined by the flange 19) will have an extension L.

Therefore, the stroke of the slide 12 will be defined by twice as much the radial distance L, i.e. 2L.

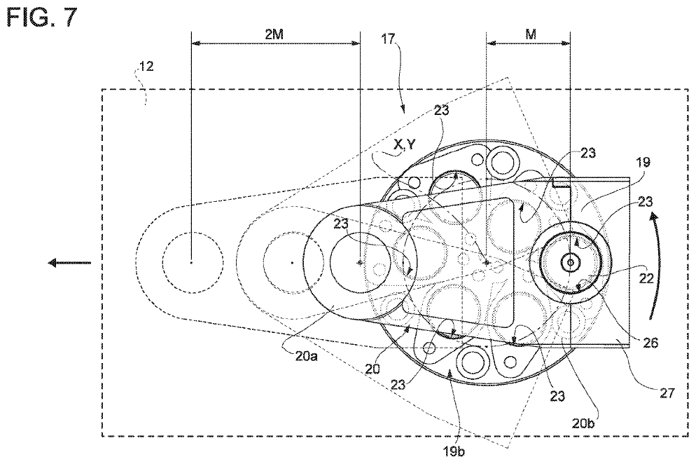

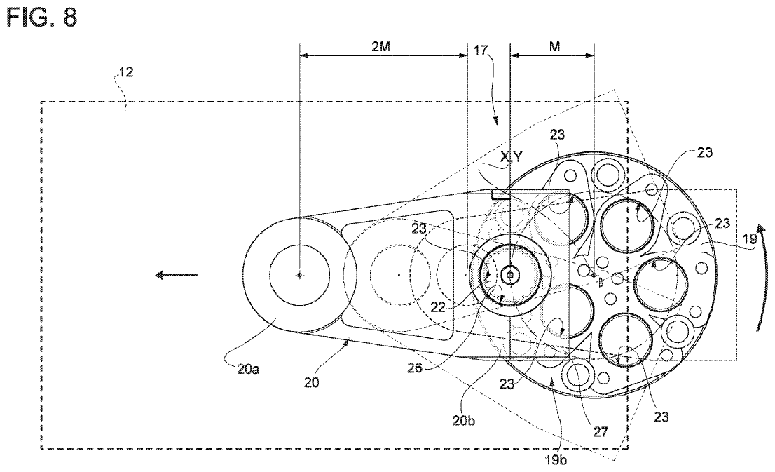

Alternatively, with reference to FIGS. 7 and 8, when the pin 22 engages the seat 23 placed at a radial distance M from the axis X for defining the coupling between the connecting rod member 20 and the flange 19, the crank member (defined by the flange 19) will have an extension M.

Therefore, the stroke of the slide 12 will be defined by twice as much the radial distance M, i.e. 2M.

Thanks to the above-described configuration, should it be necessary to change the stroke of the slide 12, in particular for manufacturing electrode plates, thus preferably monocells (and thus rechargeable batteries), having different sizes, it will be sufficient to couple the connecting rod member 20 to a different seat 23, so as to change the stroke of the slide 12 and thus modify the length of the aforementioned successive portions of strip 3 of electrode E.

As is visible in FIGS. 9, 9a, 10 and 11, the flange 19 has a first surface 19a coupled to the drive shaft 18 and a second surface 19b opposite the first one and facing the connecting rod member 20.

The seats 23 are conveniently obtained at the second surface 19b.

Properly, the second portion 20b is hinged to the flange 19 by means of the pin 22 and the first portion 20a of the connecting rod member 20 is hinged to the slide 12, in particular is coupled to the slide 12 by means of a pin 25.

In such manner, a roto-translation of the connecting rod member 20 drivable by the rotary actuator 14 via the drive shaft 18 and the flange 19 is allowed.

The connecting rod member 20 has a hole 26, preferably a through-hole, arranged at the second portion 20b and configured to be engaged by the pin 23, in particular engaged by the pin 22 in mounting and operating conditions.

Advantageously, the connecting rod member 20 comprises a retaining body 27 defining part of the second portion 20b, couplable to the connecting rod member 20 for defining the hole 26 and retaining the pin 22 therein, and (as is shown in FIG. 9a) releasable for causing a disengagement of the pin 22 from the hole 26 and a disengagement of the connecting rod member 20 from the flange 19.

In particular, the retaining body 27 is integral part of the second portion 20b of the connecting rod member 20 and is coupled in a releasable manner to the rest of the connecting rod member 20 by means of threaded members, for example two screws 28, or alternatively by means of other equivalent releasable coupling elements.

Thanks to such configuration, it is sufficient to remove the two screws 28 for releasing the body 27 from the connecting rod member 20 and determining the disengagement of the pin 22 from the hole 26 (and thus the disengagement of the connecting rod member 20 from the flange 19) and for thus being able to couple the connecting rod member 20 to another seat 23 of the flange 19 by means of the pin 22, as described above.

In other words, it is sufficient to remove the two screws 28 for changing the stroke of the slide 12, in a simple and quick manner, and without having to disassemble a large quantity of components or components having large dimensions.

Once the connecting rod member 20 has been coupled to another seat 23, it is sufficient to recouple the body 27 to the rest of the connecting rod member 20 by tightening the screws 28.

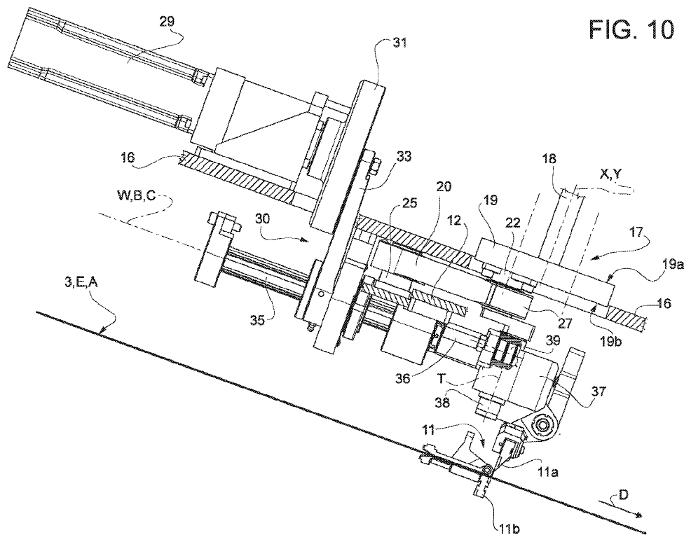

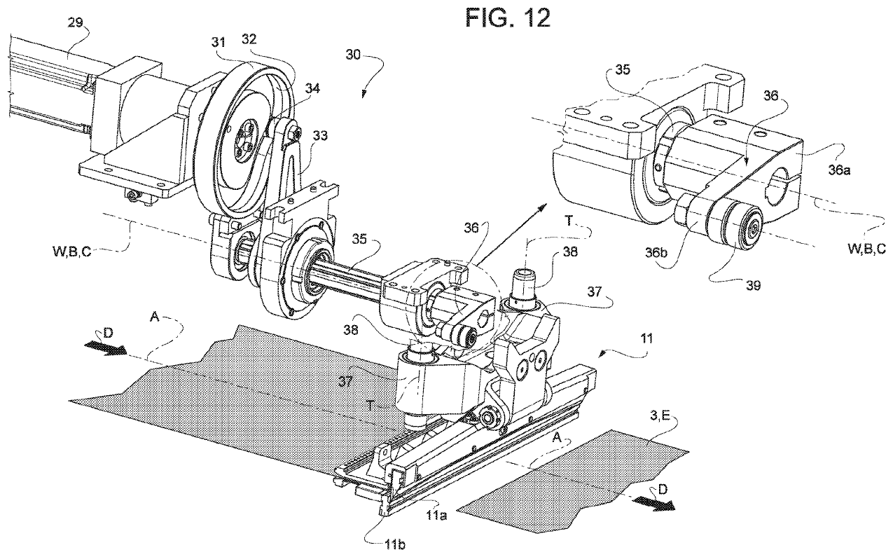

As is visible in FIG. 9 and, in particular, in FIGS. 10, 11 and 12, the machine 1 further comprises:
a second rotary actuator 29 carried by the fixed frame 16 and configured to control the aforementioned reciprocating motion of at least one of the blade 11a and the counter-blade 11b, in the described example of the blade 11a; and
a second motion transmission assembly 30 operatively interposed between the second rotary actuator 29 and the cutting assembly 11 for transforming a rotary motion output from the second rotary actuator 29 into the reciprocating motion of the at least one of the blade 11a and the counter-blade 11b, in the described example of the blade 11a.

Preferably, the second rotary actuator 29 is an electric rotary motor, for example of the brushless type, known per se and not specifically described.

According to the invention, the second transmission assembly 30 comprises:
a rotor 31 coupled to the second rotary actuator 29 for receiving the rotary motion from the latter and having a cam surface 32;
a first crank 33 carried by the fixed frame 16 and having a cam follower roller 34 cooperating with, in particular sliding on, the cam surface 32 for driving an angular oscillation of the first crank 33 relative to a rotation axis W of the latter;
a splined shaft 35 carried by the slide 12, having a longitudinal axis B coaxial to the rotation axis W and integral in rotation with the first crank 33 for angularly oscillating cyclically about its own axis B following the interaction of the cam follower 34 with the cam surface 32; and
a second crank 36 rigidly coupled, at a first portion 36a thereof, to the splined shaft 35 with its rotation axis C coaxial to the longitudinal axis and coupled, at a second eccentric (with respect to the axis C) portion 36b thereof, to the cutting assembly 11 for transmitting to the latter the angular oscillation of the splined shaft 35 and transforming it into the reciprocating motion of the blade 11a or counter-blade 11b, in the present case of the blade 11a.

In particular, the cam surface 32 is shaped (according to a known mode typical of the cams and not specifically described) so that the rotation of the rotor 31 about the rotation axis of the second rotary actuator 29 causes, through the sliding of the cam follower 34 on the cam surface 32, the angular oscillation of the first crank 33 about the axis W.

For example, the cam surface 32 comprises operating portions (or radial projections) extending radially in the direction of the rotation center of the rotor 31.

Properly, the cutting assembly 11 comprises a motion transforming mechanism 37 carrying the blade 11a, configured to receive the input motion from the second crank 36 and to linearly slide on linear guides 38 carried by the slide 12 and extending along the cutting direction T.

The second crank 36 comprises, at the second portion 36b thereof, an actuator pin 39 integral in rotation, by means of the second crank 36, with the splined shaft 35 and engaging the mechanism 37 for transmitting the aforementioned angular oscillation to the latter and thus causing a linear movement of the mechanism 37 along the linear guides 38 and the cutting direction T.

In other words, in use, the first crank 33, controlled by the rotation of the rotor 31 and by the interaction between cam follower 34 and cam surface 32, oscillates between two angular positions.

In turn, the splined shaft 35, which is integral in rotation with the first crank 33, also angularly oscillates between the two angular positions, dragging into rotation the second crank 36, which is integral in rotation with the splined shaft 35.

Therefore, the actuator pin 39 carried by the second crank 36 and eccentric with respect to the rotation axis C, will be moved between two angular positions about such axis C.

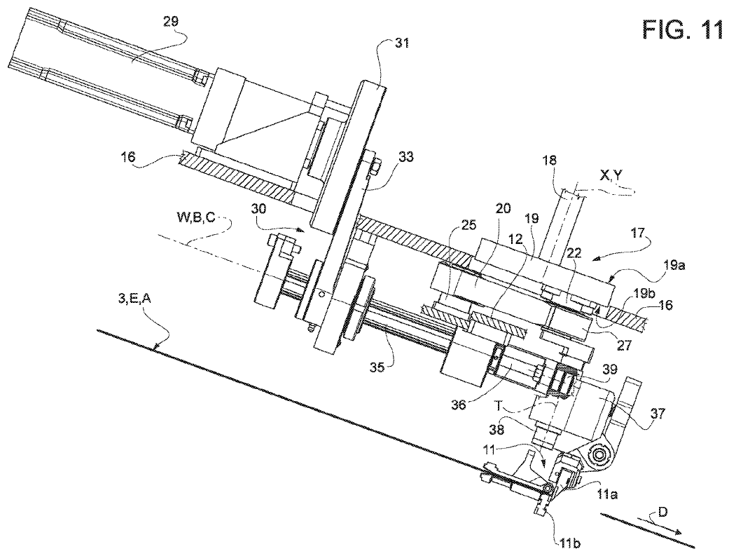

In turn, the mechanism 37, which is connected in a hinged manner to the actuator pin 39 and is linearly constrained by the linear guides 38, is moved with reciprocating motion (driven by the angular oscillations) along the cutting direction T, causing the movement of the blade 11a towards and away from the counter-blade 11b and causing the cyclic cutting of the strip 3 (FIGS. 10 and 11).

Conveniently, the splined shaft 35 is arranged with its longitudinal axis B parallel to the feeding path A and is axially slidable through the first crank 33 for moving linearly with reciprocating motion integral with the slide 12.

In other words, the first crank 33 is integral with the frame 16 together with the rotor 31 and the second rotary actuator 29, whereas the splined shaft 35 and the second crank 36 are integral with the slide 12.

Such configuration allows transferring the rotary motion from the second rotary actuator 29, fixed with respect to the frame 16, to the cutting assembly 11, movable with respect to the frame 16 since it is carried by the slide 12.

Furthermore, such configuration allows synchronizing the reciprocating motion of the slide 12 with the reciprocating motion of the blade 11a and, therefore, the gripping of the strip 3 by the gripping assembly 10 and the cutting of the strip 3 by the cutting assembly 11, in a simple and cost-effective manner.

According to preferred and non-limiting this embodiment, the gripping assembly 10 is of the type described in Italian the patent application Ser. No. 102021000014459 titled “APPARATUS FOR CUTTING AND CONVEYING A STRIP OF MATERIAL FOR THE PRODUCTION OF ELECTRICAL ENERGY STORAGE DEVICES AND RELATIVE METHOD” by the same Applicant.

In particular, as is shown in FIGS. 2, 3 and 4, the gripping assembly 10 comprises at least one pair of opposing rollers 13 each having a longitudinal axis F, arranged on opposite sides of the feeding path A, in particular with the respective longitudinal axes I transverse to the latter, and controllable between an open position (FIG. 2), in which at least one of the rollers 13 is spaced from the strip 3, and a closed position (FIGS. 3 and 4), in which the rollers 13 are pressed together for determining the gripping of the strip 3 between their external longitudinal surfaces (i.e. between their external cylindrical surfaces).

Specifically, the rollers 13 are mounted to the gripping assembly 10 with the respective axes F parallel to one another and perpendicular to the advancement direction D and to the feeding path, so as to transversely grip the strip 3 which slides between them.

In order to control the rollers 13 between the open position and the closed position, each gripping assembly comprises a first actuator (not illustrated) configured to drive the movement of (at least) one of the rollers 13 of the pair towards and away from the other one of the rollers 13 of the pair for determining, respectively, the open and closed positions of the pair.

In this non-limiting embodiment, the first actuator is defined by an electric motor, in particular brushless. In other non-limiting embodiments, the first actuator is an electric motor of a different type or arranged differently, for example at or internally one of the rollers 13.

More precisely, the first actuator is operatively connected to said one of the rollers 13 by means of a cam kinematic mechanism 15, specifically described in the aforementioned Italian patent application No. 102021000014459.

Furthermore, at least one first roller 13 of said pair of rollers 13 is advantageously actuatable in rotation about its longitudinal axis F for controlling an advancement of each portion of strip 3 (i.e. of each electrode plate), previously separated from the strip 3 (by means of the cutting assembly 11), along the feeding path A.

In particular, the first roller 13 is cyclically actuatable in rotation about its longitudinal axis F for advancing each portion of strip 3, previously separated from the strip 3 by means of the cutting assembly 11, advancing it along the feeding path A following the advancement direction D and feeding it to the rolling unit 5, more precisely to the input rollers 7 of the latter.

In other words, in use and for every cutting cycle of the single electrode (cathode or anode) from the strip 3 of electrode E:
the aforementioned rotary actuator 14 drives a movement of the slide 12 from the retracted position to the advanced position, in order to make the gripping assembly 10 (i.e. the rollers 13) and the cutting assembly 11 reach (during the movement) the advancement speed of the strip 3;
contextually, the first actuator activates the kinematic mechanism 15 which moves the pair of rollers 13 from the open position to the closed position for gripping a portion of strip 3 at the advancement speed of the strip 3;
simultaneously, the cutting assembly 11 cuts the strip 3 transversely, at the advancement speed of the latter;
at this point, while the rotary actuator 14 already controls a deceleration of the slide 12, the first roller 13, which in the present non-limiting embodiment is defined by the roller 13 proximal to the (intermediate) strip 3 of separator S to be laminated between the two strips 3 of electrode E, is actuated in rotation about its axis F for advancing the cut portion of strip 3 along the feeding path A, and in particular towards the feeding unit 5.

In other non-limiting embodiments, the roller 13 actuatable in rotation is the roller 13 distal from the intermediate strip 3 of separator S. In other non-limiting embodiments, both rollers 13 of the pair are actuatable in rotation with respective opposing synchronous motions.

In particular, the first roller 13 or both rollers 13 are configured to compensate the deceleration of the slide 12 keeping the speed of the portion of strip 3 that has just been cut substantially constant along the feeding path A towards the input rollers 7.

Preferably, the first roller 13 is actuatable in rotation when the slide 12 is positioned, i.e. when the gripping assembly 10 is positioned, between the retracted position and the advanced position.

In an alternative embodiment, the first roller 13 is actuatable in rotation when the slide 12, i.e. when the gripping assembly 10, is in the advanced position.

Thanks to the aforementioned configurations, it is possible to limit the amplitude of the reciprocating motion (i.e. the stroke) of the slide 12, since it is possible to increase the aforementioned second distance of the slide 12, and thus of the gripping assembly 10, from the input rollers 7 of the rolling unit 5.

In particular, since the portion of strip 3 previously separated is cyclically fed to such rollers 7 by means of the actuation in rotation of the first roller 13, the gripping assembly 10 can be “stopped”, in the advanced position, at a greater distance from the rollers 7 with respect to the case where the gripping assembly 10 does not comprise any roller actuatable in rotation and, therefore, has to feed the portion of strip 3 exclusively by means of the movement of the slide 12 from the retracted position to the advanced position, therefore, there is a synergic effect.

In practice, the stroke of the slide 12 can be reduced, which, since the masses and the inertias involved are relatively large, results in a better dynamic control of the same.

According to the non-limiting example described herein, the rollers 13 of the gripping assembly 10 are made of carbon fiber. This configuration is particularly, but not exclusively, advantageous in the case of the production of large-sized batteries, since such material allows manufacturing rollers 13 having a particularly extended axial dimension simultaneously preventing a high elastic arrow of the same during the production.

Preferably, the machine 1 comprises at least one further pair of opposing rollers 21, in particular a further pair of rollers 21 for each cutting and conveying apparatus 4, arranged downstream of the apparatus 4 and upstream of the rolling unit 5, relative to the advancement direction D, and configured to support each portion of strip 3 previously separated from the strip 3 between the gripping assembly 10 and the rolling unit 5. Specifically, the rollers 21 are operatively interposed between the gripping assembly 10, i.e. between the rollers 13, and the input rollers 7, relative to the advancement direction D, and are configured to sequentially receive between them the portions of strip 3 previously cut.

In practice, the further pair of rollers 21 allows providing support to each portion of strip 3 up to the proximity of the input rollers 7 so as to favor the insertion of such portion of strip 3 in the rolling unit 5 providing a suitable support.

In such manner, the stroke of the slide 12 can be further reduced, since each portion of strip 3 previously separated from the strip 3 is conveyed to the rolling unit 5 with a suitable support.

More precisely, the aforementioned second distance between the gripping assembly 10 in the advanced position and the input rollers 7 can be further increased without compromising the nominal feeding of each portion of strip 3.

Preferably, the rollers 21 of each pair are passive. Specifically, a first roller 21a is dragged into rotation by the portion of strip 3 that transits between the pair of rollers 21 and a second roller 21b is dragged by a further strip 3 of material for the production of the storage devices.

For example, as is shown in FIGS. 1 to 4, the second roller 21b is dragged by the strip 3 of separator S or by the strip 3 of protection layer P.

In such manner, no motorization of the rollers 21 of the further pair is necessary and, consequently, it is possible to reduce the total number of the components of the machine 1, further increasing the reliability thereof.

In particular, the distance between the rollers 21 and the rollers 7 corresponds to the minimum size processable by the machine 1, since the continuous gripping of the strips 3 by at least one pair of rollers is to be ensured.

According to an alternative embodiment not illustrated of the present invention, the above-described transmission assembly 17 is couplable to a machine or apparatus of different type with respect to the machine 1 and the apparatus 4.

In other words, the above-described transmission assembly 17 illustrated in the accompanying figures is advantageously implementable to every machine in which it is necessary to transmit the motion from a rotary actuator to a slide (or slide member) linearly movable with reciprocating motion between a first position and a second position, i.e. in which it is necessary to transform a rotary motion output from such rotary actuator into the reciprocating motion of the aforementioned slide.

By examining the characteristics of the machine 1 and of the relative transmission assembly 17 manufactured according to the present invention, the advantages that they allow obtaining are evident.

In particular, thanks to the transmission assembly 17 it is possible to use a rotary actuator 14 for controlling the reciprocating motion of the slide 12, in replacement of the linear motor used in the state of the art, with evident economic, dynamic and bulk advantages.

More in particular, thanks to the particular configuration of the flange 19, should it be necessary to change the stroke of the slide 12, in particular for manufacturing electrode plates, thus (half-, mono-, or bi-) cells (and thus rechargeable batteries) of different sizes, it will be sufficient to couple the connecting rod member 20 to a different eccentric seat 23, so as to change the stroke of the slide 12 and thus modify the length of the aforementioned successive portions of strip 3 of electrode E.

Additionally, thanks to the presence of the retaining body 27, it is possible to carry out such change of seat 23 in a simple and quick manner, since it is sufficient to remove the two screws 28 for releasing the body 27 from the connecting rod member 20 and for causing the disengagement of the pin 22 from the hole 26 (and thus the disengagement of the connecting rod member 20 from the flange 19) and for thus being able to couple the connecting rod member 20 to another seat 23 of the flange 19 by means of the pin 22, as described above. In other words, it is sufficient to remove the two screws 28 for changing the stroke of the slide 12, in a simple and quick manner, and without having to disassemble a large quantity of components.

Still, since the portion of strip 3 previously cut and separated is cyclically fed to the rollers 7 by means of the actuation in rotation of the first roller 13, the gripping assembly 10 can be “stopped” in the advanced position, at a greater distance from the rollers 7 with respect to the case where the gripping assembly 10 does not comprise any roller actuatable in rotation and, therefore, has to feed the portion of strip 3 exclusively by means of the movement of the slide 12 from the retracted position to the advanced position.

At the same time, the productivity of the machine 1 is increased, said machine 1 being now capable of producing a wide range of sizes keeping the speed of the strips 3 high (according to the prior art, the small sizes, for example for batteries for consumer electronics, can be produced at reduced speeds with respect to the very large sizes, for example for the automotive sector).

In other words, the braking distance to be ensured between the gripping assembly 10 in the advanced position and the rolling unit 5 is reduced, since the gripping assembly 10 is capable of feeding each portion of strip 3 to the rollers 7 from a greater distance, thanks to the first roller 13 actuatable in rotation.

This allows reducing the stroke of the slide 12 and controlling a slowing down of the slide 12 earlier, with respect to the known case. Considering the high speed at which the machine 1 operates and the inertias involved, the foregoing results in a better dynamic control of the slide 12.

Furthermore, the flexibility of the machine 1 is improved, since the need to replace the rotary actuator 14 following a change of size of the rechargeable batteries is at least limited, given that it is possible to control the entity of the rotation of the first roller 13 actuatable in rotation.

Finally, the presence of the further pairs of rollers 21 allows further reducing the stroke of the slide 12, since each portion of strip 3 previously separated from the strip 3 is conveyed to the rolling unit 5 with a suitable support.

It is clear that modifications and variations can be made to the machine 1 and to the relative transmission assembly 17 described and illustrated herein and to the production method described herein without thereby departing from the scope of protection defined by the claims.

1. Automatic machine (1) for the production of electrical energy storage devices comprising:
a feeding unit (2) for feeding at least one strip (3) of material for the production of the storage devices along a respective feeding path (A) and in an advancement direction (D);
at least one cutting and conveying apparatus (4) for cutting and conveying the strip (3) of material arranged downstream of the feeding unit (2), relative to said advancement direction (D), and comprising a slide (12) linearly movable with reciprocating motion parallel to the feeding path (A) between a retracted position and an advanced position, the slide (12) carrying a gripping assembly (10) for sequentially gripping the strip (3) at successive portions thereof, and a cutting assembly (11) for sequentially cutting the strip (3) when the latter is gripped by the gripping assembly (10) to determine the sequential separation of said successive portions from the strip (3); and
a rotary actuator (14) carried by a fixed frame (16) of the automatic machine (1) and configured to control said reciprocating motion of the slide (12) between the retracted position and the advanced position;
wherein the automatic machine (1) further comprises a motion transmission assembly (17) operatively interposed between the rotary actuator (14) and the slide (12) for transforming a rotary motion output from the rotary actuator (14) into the reciprocating motion of the slide (12) and including:
a drive shaft (18) carried by the fixed frame (16), having a longitudinal rotation axis (X) and coupled to the rotary actuator (14) to receive the rotary motion from the latter;
a crank member (19) coupled to the drive shaft (18) to receive the rotary motion from the latter; and
a connecting rod member (20) coupled, at a first portion (20a) thereof, to the slide (12) and couplable, at a second portion (20b) thereof opposite the first one, to the crank member (19) eccentrically with respect to said rotation axis (X) for receiving the rotary motion from the crank member (19) and transforming it into said reciprocating motion.

2. Automatic machine (1) as claimed in claim 1, wherein the transmission assembly (17) comprises a coupling flange (19) interposed between the drive shaft (18) and the connecting rod member (20), carried by the drive shaft (18) coaxially to said rotation axis (X), couplable to the second portion (20b) of the connecting rod member (20) by means of a coupling pin (22), and having at least two seats (23) eccentric with respect to the rotation axis (X) and configured to selectively receive said pin (22);
and wherein the at least two eccentric seats (23) are arranged at respective radial distances (L, M) from the rotation axis (X) distinct from one another.

3. Automatic machine (1) as claimed in claim 2, wherein the coupling flange (19) defines said crank member, whose extension is defined by the radial distance (L, M) between the eccentric seat (23) engaged by the pin (22), to define the coupling between the connecting rod member (20) and the flange (19), and the rotation axis (X), such extension being variable according to the eccentric seat (23) engaged.

4. Automatic machine (1) as claimed in claim 2, wherein the coupling flange (19) has a first surface (19a) coupled to the drive shaft (18) and a second surface (19b) opposite the first one and facing the connecting rod member (20), said eccentric seats (23) being obtained at the second surface (19b);
and wherein the connecting rod member (20) is selectively couplable, by means of said pin (22), to one of the eccentric seats (23) to define respective distinct strokes (2L, 2M) of the slide (12) between the retracted position and the advanced position.

5. Automatic machine (1) as claimed in claim 2, wherein the first portion (20a) of the connecting rod member (20) is hinged to the slide (12), and wherein the second portion (20b) of the connecting rod member (20) is hinged to the coupling flange (19) by means of said pin (22), so as to allow a roto-translation of the connecting rod member (20) drivable by the rotary actuator (14) via the drive shaft (18) and the coupling flange (19).

6. Automatic machine (1) as claimed in claim 2, wherein the connecting rod member (20) has a hole (26) arranged at the second portion (20b) and configured to be engaged by the coupling pin (22);
the connecting rod member (20) comprising a retaining body (27) defining part of said second portion (20b), couplable to the connecting rod member (20) to define said hole (26) and retain the pin (22) therein, and releasable to cause a disengagement of the pin (22) from the hole (26) and a disengagement of the connecting rod member (20) from the coupling flange (19).

7. Automatic machine (1) as claimed in claim 1, wherein the cutting assembly (11) comprises a blade (11a) and a counter-blade (11b), at least one of which is movable with reciprocating motion along a cutting direction (T) transversal to the feeding path (A) for sequentially cutting the strip (3);
and wherein the machine (1) further comprises:
a second rotary actuator (29) carried by the fixed frame (16) and configured to control said reciprocating motion of at least one of the blade (11a) and the counter-blade (11b); and
a second motion transmission assembly (30) operatively interposed between the second rotary actuator (29) and the cutting assembly (11) for transforming a rotary motion output from the second rotary actuator (29) into the reciprocating motion of the at least one of the blade (11a) and the counter-blade (11b).

8. Automatic machine (1) as claimed in claim 7, wherein the second transmission assembly (30) comprises:
a rotor (31) coupled to the second rotary actuator (29) to receive the rotary motion from the latter and having a cam surface (32);
a first crank (33) carried by the fixed frame (16) and having a cam follower (34) configured to cooperate with the cam surface (32) of the rotor (31) to drive an angular oscillation of the first crank (33) relative to a rotation axis (W) of the latter;
a splined shaft (35) carried by the slide (12), having a longitudinal axis (B) coaxial to the rotation axis (W) of the first crank (33), and integral in rotation with the first crank (33) to angularly oscillate cyclically about its own axis (B) following the interaction of the cam follower (34) with the cam surface (32); and
a second crank (36) rigidly coupled, at a first portion (36a) thereof, to the splined shaft (35) with its rotation axis (C) coaxial to the longitudinal axis (B) and coupled, at a second eccentric portion (36b) thereof, to the cutting assembly (11) for transmitting to the latter the angular oscillation of the splined shaft (35) and transforming it into the reciprocating motion of the blade (11a) or counter-blade (11b).

9. Automatic machine (1) as claimed in claim 8, wherein the splined shaft (35) is arranged with its longitudinal axis (B) parallel to the feeding path (A) and is axially slidable through the first crank (33) to move linearly with reciprocating motion integral with the slide (12).

10. Automatic machine (1) as claimed in claim 8, wherein the cutting assembly (11) comprises a motion transforming mechanism (37) carrying the blade (11a), configured to receive the motion input from the second crank (36) and to slide linearly on linear guides (38) carried by the slide (12) and extending along the cutting direction (T);
wherein the second crank (36) comprises, at the second portion (36b) thereof, an actuator pin (39) integral in rotation, by means of the second crank (36), with the splined shaft (35) and engaging the transformation mechanism (37) to transmit said angular oscillation to the latter and thus cause a linear movement of the mechanism (37) along the linear guides (38) and the cutting direction (T).

11. Motion transmission assembly (17) for transmitting motion from a rotary actuator (14) to a slide (12) linearly movable with reciprocating motion between a first position and a second position, the transmission assembly (17) comprising:
a drive shaft (18) having a longitudinal rotation axis (X) and coupled to the rotary actuator (14) for receiving a rotary motion from the latter;
a coupling flange (19) defining a crank member and coupled to the drive shaft (18) coaxially to the rotation axis (X) for receiving the rotary motion therefrom;
a connecting rod member (20) coupled, at a first portion (20a) thereof, to the slide (12) and couplable, at a second portion (20b) thereof opposite the first one, to the flange (19) eccentrically with respect to said rotation axis (X) for receiving the rotary motion from the coupling flange (19) and transforming it into said reciprocating motion;
wherein the coupling flange (19) is interposed between the drive shaft (18) and the connecting rod member (20), is couplable to the second portion (20b) of the connecting rod member (20) by means of a coupling pin (22), and has at least two seats (23) eccentric with respect to the rotation axis (X) configured to selectively receive said pin (22);
and wherein the at least two eccentric seats (23) are arranged at respective radial distances (L, M) from the rotation axis (X) distinct from one another.

12. Transmission assembly as claimed in claim 11, wherein the extension of the crank member defined by the coupling flange (19) is defined by the radial distance (L, M) between the eccentric seat (23) engaged by the pin (22), to define the coupling between the connecting rod member (20) and the flange (29), and the rotation axis (X), such extension being variable according to the eccentric seat (23) engaged.
